(19) United States
(12) Patent Application Publication
(10) Pub. No.: US 2018/0319234 A1
(43) Pub. Date: Nov. 8, 2018

(54) SPRING STRUT FOR A VEHICLE SUSPENSION SYSTEM

(71) Applicant: DEERE & COMPANY, Moline, IL (US)

(72) Inventors: MATHIAS L. KLITTICH, Mannheim (DE); GUENTHER WOLF, Worms (DE); CHRISTIAN VON HOLST, Kesselgraben (DE); KLAUS HAHN, Mannheim (DE)

(21) Appl. No.: 15/973,654

(22) Filed: May 8, 2018

(30) Foreign Application Priority Data
May 8, 2017 (DE) 102017207690.9

(51) Int. Cl. B60G 15/12; B60G 9/02

(52) U.S. Cl. CPC B60G 15/12; B60G 9/02; B60G 2206/72; B60G 2206/8111; B60G 2800/162; B60G 2202/30; B60G 2206/40; B60G 2300/082; B60G 2200/32

(57) ABSTRACT

A spring strut for a vehicle suspension system includes a spring cylinder defining a cylinder chamber and a spring piston longitudinally displaceable in the spring cylinder. The spring piston subdivides the cylinder chamber into a first and a second outer working chamber. The spring cylinder includes an inner plunger which subdivides a piston chamber formed by the spring piston into a first and a second inner working chamber. The first inner working chamber is simultaneously formed by subdividing the cylinder chamber by means of the spring piston.

### RELATED APPLICATIONS

This application claims priority to German Patent Application Ser. No. 102017207690.9, filed May 8, 2017, the disclosure of which is hereby incorporated by reference in its entirety.

### FIELD OF THE DISCLOSURE

The present disclosure relates to a spring strut for a vehicle suspension system, and in particular to a spring cylinder and spring piston longitudinally displaceable in the spring cylinder, wherein the spring piston subdivides a cylinder chamber formed by the spring cylinder into a first and second outer working chamber.

### BACKGROUND

A spring strut in the form of a wheel spring cylinder can be found, for example, in DE 198 53 876 A1, where it is paired with a double-chamber cylinder to provide a roll stabilization function. Due to the structurally separated design of the wheel spring cylinder and the double chamber cylinder, the required installation space of the known arrangement is correspondingly large.

There is a need, however, for an improved spring strut capable of space-saving use in a roll-stabilizing vehicle suspension system.

### SUMMARY

In a first embodiment of the present disclosure, a spring strut for a vehicle suspension system includes a spring cylinder and a spring piston longitudinally displaceable in the spring cylinder, wherein the spring piston subdivides the cylinder chamber formed by the spring cylinder into a first and second outer working chamber. According to this embodiment, the spring cylinder has an inner plunger, which subdivides a piston chamber formed by the spring piston into a first and a second inner working chamber, wherein the first inner working chamber is simultaneously formed by subdividing the cylinder chamber by means of the spring piston.

Due to the nested arrangement of the working chambers created in this manner, the spring strut is characterized by a particularly compact structure. The two inner working chambers communicate via passages formed in the inner plunger with a respective pressure connection piece on an outer side of the spring cylinder. The pressure connection piece is screwed in the form of a threaded fitting into a through-hole thread formed on the spring cylinder and opening into the respective inner working chamber.

There further exists the possibility that the spring piston, together with the spring cylinder and the inner plunger, can form an inner and an outer annular space. In more precise terms, the inner annular space can be the first inner working chamber and the outer annular space can be the first outer working chamber. In particular, the outer annular space can concentrically surround the inner annular space, which leads to a more compact structure of the spring strut.

It can be provided that the spring piston has a central opening, through which a solid cylindrical plunger base comprised by the inner plunger extends, in the region of a piston head.

Additionally or alternatively, the spring cylinder can have an annular gap running between an end-face cylinder cover and a plunger head of the inner plunger, through which annular gap a hollow cylindrical piston base comprised by the spring piston extends.

The solid cylindrical plunger base and the hollow cylindrical piston base are mounted in this case fluid-tightly and longitudinally displaceable within the central opening or the annular gap, respectively.

It is also possible that the inner plunger protrudes centrally in the region of a cylinder bottom, wherein the plunger base comprised by the inner plunger can be, in particular, integral with the spring cylinder. The first outer working chamber in such a case is formed as an additional outer annular space.

The two outer working chambers can communicate via passages formed in a cylinder wall with a respective pressure connection piece on an outer side of the spring cylinder. The pressure connection piece here as well can be screwed in the form of a threaded fitting into a through-hole thread formed on the spring cylinder and opening into the respective outer working chamber.

In consideration of a simplified assembly of the spring strut, the spring cylinder or the spring piston can be formed in multiple parts. Thus the piston head can be removably mounted on the spring piston or the piston base comprised by the latter, and the plunger head can be removably mounted on the plunger base. For this purpose, a detachable fastener in the form of a threaded fitting or the like can be provided between the parts in question.

The spring strut is a component of a vehicle suspension system for an agricultural tractor, for example. In this case, the vehicle suspension system comprises right-hand and left-hand spring struts of the design according to the present disclosure. The first inner working chamber of the left-hand spring strut communicates with the second inner working chamber of the right-hand spring strut via a first cross line, and the first inner working chamber of the right-hand spring strut communicates with the second inner working chamber of the left-hand spring strut via a second cross line. Each of the two cross lines here is connected to a separate bladder accumulator.

The hydraulic system formed by the cross connection of the inner working chambers (fluidically closed per se) leads to a roll stabilization of the vehicle structure supported by means of the two spring struts with respect to associated wheel carriers or a vehicle axle. For example, if the vehicle body leans to the left, this causes a compression of the left-hand spring strut together with a corresponding extension of the right-hand spring strut. Hydraulic fluid is displaced as a corresponding compensation volume flow from the second inner working chamber of the left-hand spring strut and the first inner working chamber of the right-hand spring strut in the direction of the second inner working chamber of the right-hand spring strut and the first inner working chamber of the left-hand spring strut, respectively. This ultimately leads to a mutual blocking of the two spring struts. A lateral roll movement of the vehicle body is effectively suppressed in this manner. The two bladder accumulators are used for compensation for the typically different displacement volumes of the first and second inner working chambers, and for achieving a defined damping behavior.

In other words, the cross connection of the two spring struts counters opposite-phase movements of the vehicle body, while in-phase movements are permitted, so that the “usual” suspension function of the vehicle suspension system performed by means of the outer working chambers is not impaired. In other words, the outer working chambers are typically connected to an arrangement of multiple additional bladder accumulators, wherein a modification of the position of the vehicle body is possible via associated supply lines by adapting a preload pressure in the outer working chambers by means of a hydraulic system of the agricultural tractor. In this regard, the reader is referred to the arrangement according to DE 196 43 263 A1 for the case of a suspended rigid axle of an agricultural tractor and the like.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 shows a schematically represented embodiment of the spring strut; and

FIG. 2 shows a vehicle suspension system of an agricultural tractor having a right-hand and a left-hand spring strut according to FIG. 1.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

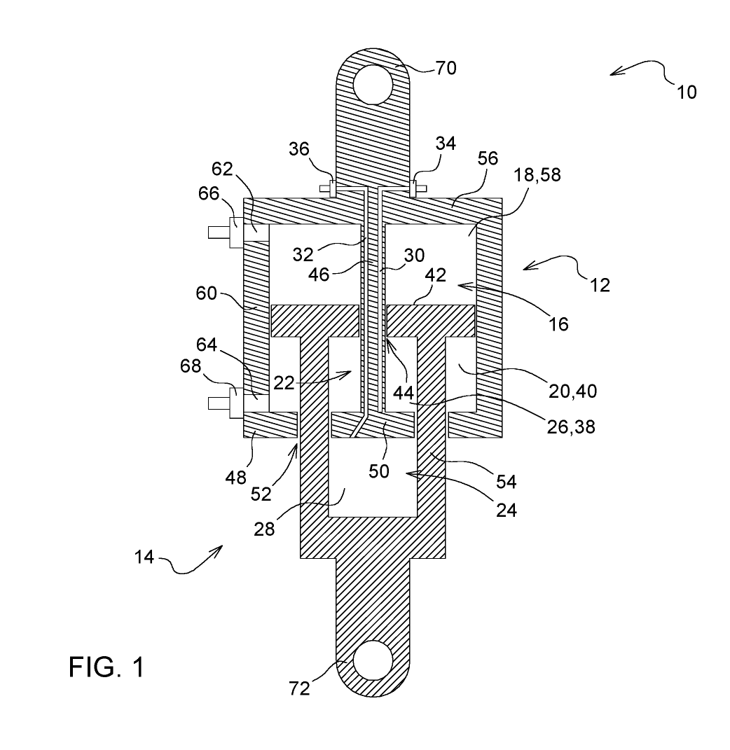

FIG. 1 shows a sectional schematic representation of the spring strut according to a first embodiment of the present disclosure. The spring strut 10 includes a spring cylinder 12 and a spring piston 14 that can be longitudinally displaced in the spring cylinder 12. The spring piston 14 subdivides a cylinder chamber 16 formed by the spring cylinder 12 into a first and a second outer working chamber 18, 20. The spring cylinder 12 additionally has an inner plunger 22, which subdivides a piston chamber 24 formed by the spring piston 14 into a first and a second inner working chamber 26, 28, wherein the first inner working chamber 26 is simultaneously formed by subdividing the cylinder chamber 16 by means of the spring piston 14.

The two inner working chambers 26, 28 communicate via first and second passages 30, 32 formed in the inner plunger 22 with a first and a second pressure connection piece 34, 36 on an outer side of the spring cylinder 12. The first and second pressure connection pieces 34, 36 are screwed into a respective through-hole thread formed on the spring cylinder 12 and opening into the respective inner working chamber 26, 28.

Together with the spring cylinder 12 and the inner plunger 22, the spring piston 14 forms an inner and an outer annular space 38, 40. In more precise terms, the inner annular space 38 is the first inner working chamber 26 and the outer annular space 40 is the first outer working chamber 18. The outer annular space 40 is concentrically surrounding the inner annular space 38.

According to this embodiment, the spring piston 14 has in the region of a piston head 42 a central opening 44 in the form of a through-bore through which the solid cylindrical plunger base 46 comprised by the inner plunger 22 penetrates. The spring cylinder 12 can additionally have an annular gap 52 running between an end-face cylinder cover 48 and a plunger head 50 of the inner plunger 22 through which annular gap a hollow cylindrical piston base 54 comprised by the spring piston 14 extends. The solid cylindrical plunger base 46 and the hollow cylindrical piston base 54 are mounted fluid-tightly and longitudinally displaceable within the central opening 44 and the annular gap 52, respectively.

According to FIG. 1, the inner plunger 22 protrudes centrally in the region of a cylinder bottom 56, the plunger basis 46 thereof being an integral component of the spring cylinder 12. The first outer working chamber 18 is therefore formed as an additional outer annular space 58.

The two outer working chambers 18, 20 communicate via a third and a fourth passage 62, 64 formed in a cylinder wall 60 with a respective pressure connection piece 66, 68 on an outer side of the spring cylinder 12. The third and the fourth pressure connection pieces 66, 68 here as well are screwed in the form of a threaded fitting into a through-hole thread formed on the spring cylinder 12 and opening into the respective inner working chamber 18, 20.

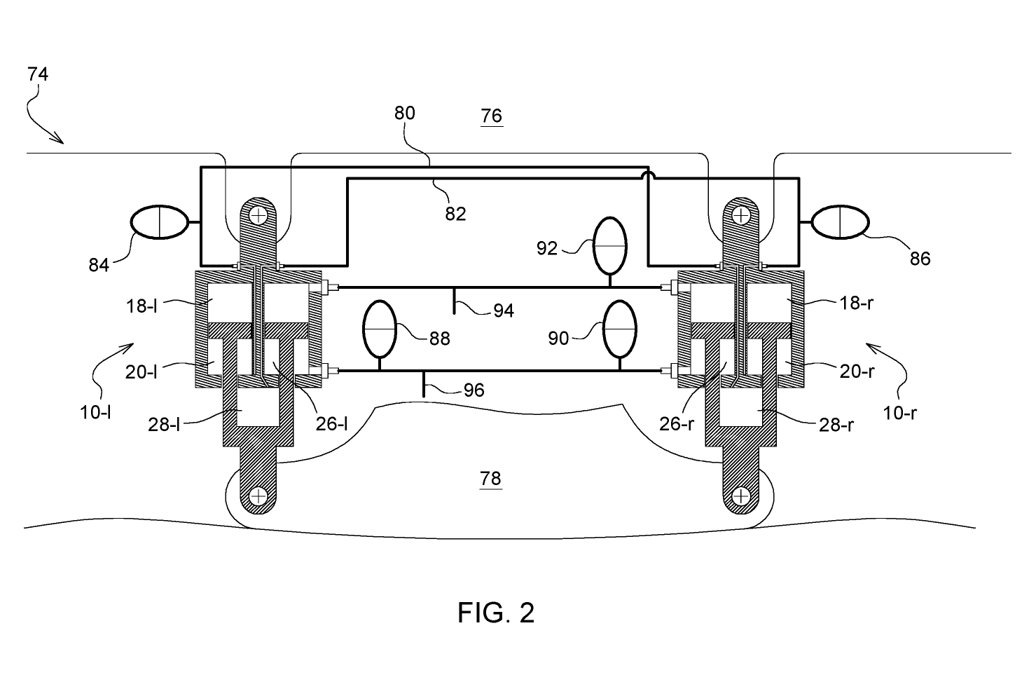

Both the spring cylinder 12 and the spring piston 14 are produced as cast steel parts, wherein each of the fluid-tight passages formed in the region of the central opening 44 or the annular gap 52 is further worked by metal cutting machining. On opposite ends of the spring strut 10, there are first and second fastening eyes 70, 72, which enable an attachment between a wheel carrier or a vehicle axle and a vehicle body (see FIG. 2).

In consideration of a simplified assembly of the spring strut 10, the spring cylinder 12 or the spring piston 14 can be formed in multiple parts. Thus, the piston head 42 can be removably mounted on the spring piston 14 or the piston base 54 comprised by the latter, and the plunger head 50 can be removably mounted on the plunger base 46. For this purpose, a detachable fastener (not shown) in the form of a threaded fitting or the like is provided between the parts in question.

FIG. 2 shows a vehicle suspension system of an agricultural tractor including a right-hand and a left-hand spring strut according to FIG. 1, wherein the associated reference signs are indicated by “r” (right-hand) or “l” (left-hand) depending on the respective side with which they are associated.

According to the example shown in FIG. 2, the two identically constructed spring struts 10-r and 10-l of the vehicle suspension system 74 are used for supporting a vehicle body 76 with respect to a suspended rigid axle 78 of the agricultural tractor. The rigid axle 78 in the present case is a freely suspended front axle. Alternatively, the spring struts 10-r, 10-l may also be arranged in connection with a single wheel suspension between a respective wheel carrier and the vehicle body 76.

As can be seen in FIG. 2, the first inner working chamber 26-l of the left-hand spring strut 10-l communicates with the second inner working chamber 28-r of the right-hand spring strut 10-r via a first cross line 80, and the first inner working chamber 26-r of the right-hand spring strut 10-r communicates via a second cross line 82 with the second inner working chamber 28-l of the left-hand spring strut 10-l. Each of the two cross lines 80, 82 is connected to a separate bladder accumulator 84, 86. The bladder accumulators 84, 86 are designed as nitrogen-filled diaphragm accumulators.

The hydraulic system (fluidically closed off per se) formed on the basis of the illustrated cross connection of the inner working chambers 26-r, 28-r, 26-l, 28-l leads to a roll stabilization of the vehicle body 76. If the vehicle body 76 leans to the left as in the example illustrated in FIG. 2, this causes a compression of the left-hand spring strut 10-l together with a corresponding extension of the right-hand spring strut 10-r. Hydraulic fluid is displaced as a corresponding compensation volume flow from the second inner working chamber 28-l of the left-hand spring strut 10-l and the first inner working chamber 26-r of the right-hand spring strut 10-r in the direction of the second inner working chamber 28-r of the right-hand spring strut 10-r and the first inner working chamber 26-l of the left-hand spring strut 10-l, respectively. This ultimately leads to a mutual blocking of the two spring struts 10-r, 10-l. A lateral roll movement of the vehicle body 76 is effectively suppressed in this manner. The two bladder accumulators 84, 86 are used for compensation for the typically different displacement volumes of the first and second inner working chambers 26-r, 28-r, 26-l, 28-l, and for achieving a defined damping behavior.

In other words, the cross connection of the two spring struts 10-r, 10-l counters opposite-phase movements of the vehicle body 76, while in-phase movements are permitted, so that the “usual” suspension function of the of the vehicle suspension system performed by means of the outer working chambers 18-r, 20-r, 18-l, 20-l is not impaired. For this purpose, the outer working chambers 18-r, 20-r, 18-l, 20-l are connected to an arrangement of multiple additional bladder accumulators 88, 90, 92. Here, a modification of the position of the vehicle body 76 is possible via associated supply lines 94, 96 by adapting a preload pressure in the outer working chambers 18-r, 20-r, 18-l, 20-l by means of a hydraulic system of the agricultural tractor. The additional bladder accumulators 88, 90, 92 are also designed as nitrogen-filled diaphragm storage units. In this sense, the functioning of the vehicle suspension system 74 corresponds to that of conventional arrangements as known, for example, from DE 196 43 263 A1.

For the sake of completeness, it should be noted that the illustrated usage of the vehicle suspension system 74 in an agricultural tractor is only one example, and the use thereof is also possible in any other utility vehicle. In addition, the above configuration can also be used in conjunction with an active vehicle cab suspension, the spring struts being arranged in that case between a supporting vehicle structure and a frame of an operator cab.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A spring strut for a vehicle suspension system, comprising:
a spring cylinder defining a cylinder chamber;
a spring piston longitudinally displaceable in the spring cylinder, wherein the spring piston subdivides the cylinder chamber into a first and a second outer working chamber;
wherein, the spring cylinder comprises an inner plunger which subdivides a piston chamber formed by the spring piston into a first and a second inner working chamber;
wherein, the first inner working chamber is simultaneously formed by subdividing the cylinder chamber by means of the spring piston.

2. The spring strut of claim 1, wherein the two inner working chambers communicate with a first and a second pressure connection piece located on an outer side of the spring cylinder via respective first and second passages formed in the inner plunger.

3. The spring strut of claim 1, wherein the spring piston, the spring cylinder, and the inner plunger form an inner and an outer annular space.

4. The spring strut of claim 1, wherein in the region of a piston head, the spring piston comprises a central opening through which a solid cylindrical plunger base comprised by the inner plunger extends.

5. The spring strut of claim 1, wherein:
the spring cylinder comprises an annular gap running between an end-face cylinder cover and a plunger head of the inner plunger; and
the spring piston is configured to extend through which the annular gap.

6. The spring strut of claim 1, wherein the inner plunger protrudes centrally in the region of a cylinder bottom, the plunger base being an integral component of the spring cylinder.

7. The spring strut of claim 1, wherein the two outer working chambers communicate via first and second passages formed in a cylinder wall with a respective first and second pressure connection piece on an outer side of the spring cylinder.

8. The spring strut of claim 1, wherein the spring cylinder or the spring piston is formed in multiple parts.

9. A vehicle suspension system, comprising:
a right-hand and a left-hand spring strut both comprising:
a spring cylinder defining a cylinder chamber, a spring piston longitudinally displaceable in the spring cylinder, wherein the spring piston subdivides the cylinder chamber into a first and a second outer working chamber;
wherein, the spring cylinder comprises an inner plunger which subdivides a piston chamber formed by the spring piston into a first and a second inner working chamber;
wherein, the first inner working chamber is simultaneously formed by subdividing the cylinder chamber by means of the spring piston.
the first inner working chamber of the left-hand spring strut being in fluid communication with the second inner working chamber of the right-hand spring strut via a first cross line, and the first inner working chamber of the right-hand spring strut being in fluid communication via a second cross line with the second inner working chamber of the left-hand spring strut, wherein each of the two cross lines is connected to a separate bladder accumulator.

10. The vehicle suspension system of claim 9, wherein the two inner working chambers communicate with a first and a second pressure connection piece located on an outer side of the spring cylinder via respective first and second passages formed in the inner plunger.

11. The vehicle suspension system of claim 9, wherein the spring piston, the spring cylinder, and the inner plunger form an inner and an outer annular space.

12. The vehicle suspension system of claim 9, wherein in the region of a piston head, the spring piston comprises a central opening through which a solid cylindrical plunger base comprised by the inner plunger extends.

13. The vehicle suspension system of claim 9, wherein:
the spring cylinder comprises an annular gap running between an end-face cylinder cover and a plunger head of the inner plunger; and
the spring piston is configured to extend through which the annular gap.

14. The vehicle suspension system of claim 9, wherein the inner plunger protrudes centrally in the region of a cylinder bottom, the plunger base being an integral component of the spring cylinder.

15. The vehicle suspension system of claim 9, wherein the two outer working chambers communicate via first and second passages formed in a cylinder wall with a respective first and second pressure connection piece on an outer side of the spring cylinder.

16. The vehicle suspension system of claim 9, wherein the spring cylinder or the spring piston is formed in multiple parts.

17. A utility vehicle, comprising:
a vehicle body; and
a vehicle suspension system for supporting the vehicle body, the vehicle suspension system including a right-hand and a left-hand spring strut, where the right-hand and left-hand spring struts comprise:
a spring cylinder defining a cylinder chamber, a spring piston longitudinally displaceable in the spring cylinder, wherein the spring piston subdivides the cylinder chamber into a first and a second outer working chamber;
wherein, the spring cylinder comprises an inner plunger which subdivides a piston chamber formed by the spring piston into a first and a second inner working chamber;
wherein, the first inner working chamber is simultaneously formed by subdividing the cylinder chamber by means of the spring piston.
the first inner working chamber of the left-hand spring strut being in fluid communication with the second inner working chamber of the right-hand spring strut via a first cross line, and the first inner working chamber of the right-hand spring strut being in fluid communication via a second cross line with the second inner working chamber of the left-hand spring strut, wherein each of the two cross lines is connected to a separate bladder accumulator.

18. The utility vehicle of claim 17, wherein the two inner working chambers communicate with a first and a second pressure connection piece located on an outer side of the spring cylinder via respective first and second passages formed in the inner plunger.

19. The utility vehicle of claim 17, wherein the spring piston, the spring cylinder, and the inner plunger form an inner and an outer annular space.

20. The utility vehicle of claim 17, wherein in the region of a piston head, the spring piston comprises a central opening through which a solid cylindrical plunger base comprised by the inner plunger extends.
